(19) United States
(12) Patent Application Publication
(10) Pub. No.: US 2016/0200269 A1
(43) Pub. Date: Jul. 14, 2016

(54) WIRE HARNESS

(71) Applicant: Yazaki Corporation, Tokyo (JP)

(72) Inventors: Ryohei INOUE, Shizuoka (JP); Yasuyuki YAMADA, Shizuoka (JP); Yuji TSUCHIYA, Shizuoka (JP)

(73) Assignee: Yazaki Corporation, Tokyo (JP)

(21) Appl. No.: 15/075,418

(22) Filed: Mar. 21, 2016

Related U.S. Application Data
(63) Continuation of application No. PCT/JP2014/069342, filed on Jul. 22, 2014.

(30) Foreign Application Priority Data
Sep. 26, 2013 (JP) 2013-199316

(51) Int. Cl. B60R 16/02

(52) U.S. Cl. CPC B60R 16/0207

(57) ABSTRACT

A wire harness includes: an electric wire including a conductor part and an insulator part that covers the conductor part; a shield part that is composed of a separate body from the electrical wire and covers the electric wire; and a rigid first exterior part that intermittently covers the shield part in the longitudinal direction of the shield part.

### CROSS REFERENCE TO RELATED APPLICATIONS

This application is a continuation of International Application No. PCT/JP2014/069342, filed Jul. 22, 2014, and based upon and claims the benefit of priority from Japanese Patent Application No. 2013-199316, filed Sep. 26, 2013, the entire contents of all of which are incorporated herein by reference.

### TECHNICAL FIELD

The present application relates to a wire harness, and in particular relates to a wire harness in which its part is made rigid.

### BACKGROUND

As a conventional example, an electric wire 301 such as one illustrated in FIG. 8 is known (see JP 2008-071525 A). In the electric wire 301 relating to the conventional example, a core wire 303 is coated with an insulator part 305, and the insulator part 305 is covered with a shield part 307 composed of a braided wire, and the shield part 307 is coated with a sheath part 309. Further, the electric wire 301 is covered with a corrugate 311 as an outer layer.

The electric wire 301 is manufactured by going through processes such as illustrated in FIG. 9. In other words, the core wire 303 is generated by casting, rolling, wire drawing, and making strands of a metal material. The insulator part 305 is formed by coating the core wire 303 by extruding resin around the core wire 303.

Subsequently, after providing the shield part 307 around the insulator part 305, the sheath part 309 is formed by coating the shield part 307 by extruding resin around the shield part 307, by which the electric wire 301 is obtained. Subsequently, the electric wire 301 is inserted into the corrugate 311 by extruding the corrugate 311.

### SUMMARY

The electric wire that has been inserted into the corrugate (wire harness) 313 has the electric wire 301 covered with the corrugate 311. Therefore, in a case that it is used as a wire harness or the like of an automobile, it has high durability against friction, crushing or the like. However, since it is necessary that the electric wire 301 is inserted through the corrugate 311 after the electric wire 301 is generated, there are problems in that the manufacturing process of the wire harness 313 becomes complex, and it takes long for the manufacturing and the cost is increased.

Yet, the sheath part 309 is necessary to avoid contact between the shield part 307 and the corrugate 311, and it is difficult to eliminate it for the simplification of the manufacturing process.

Moreover, with the wire harness 313, since the shape of the corrugate 311 is not fixed (since it changes easily), there is a problem that assemble workability at the time of installation to a wire harness installation body of a vehicle or the like is not good.

The present application was made in light of the above-described problems and it aims to provide a wire harness which can shorten the manufacturing time and suppress the increase of the cost by simplifying the manufacturing process, and which has good assembly workability to the wire harness installation body of a vehicle or the like.

A wire harness according to a first aspect of the present application includes one or more electric wires each including a conductor part and an insulator part that covers the conductor part; a shield part that is composed of a separate body from the electric wires and covers the electric wires; and a rigid first exterior part that intermittently covers the shield part in the longitudinal direction of the shield part.

The wire harness according to the first aspect of the present application may further include a flexible second exterior part that is provided between the first exterior part and continuously covers the shield part in the longitudinal direction of the shield part in cooperation with the first exterior part.

The wire harness according to the first aspect of the present application may further include a flexible second exterior part that continuously covers the shield part in the longitudinal direction of the shield part, and the first exterior part may intermittently cover the second exterior part in the longitudinal direction of the second exterior part.

A wire harness according to a second aspect of the present application includes one or more electric wires each including a conductor part and an insulator part that covers the conductor part; and a rigid exterior part that is composed of a separate body from the electric wires and intermittently covers the insulator parts in the longitudinal direction of the electric wires.

According to the first aspect or the second aspect of the present application, an effect of providing a wire harness which can shorten the manufacturing time and suppress an increase of the cost by simplifying the manufacturing process and which has good assembly workability to a wire harness installation body of a vehicle or the like is exhibited.

### BRIEF DESCRIPTION OF DRAWINGS

FIG. 1 is a perspective view of a wire harness according to an embodiment.

FIG. 2 is a figure illustrating a manufacturing process of the wire harness according to the embodiment.

FIG. 3 is a figure illustrating an installation process of an exterior part of the wire harness according to the embodiment.

FIG. 4 is a figure illustrating an installation process of an exterior part of the wire harness according to the embodiment.

FIG. 5 is a figure illustrating an installation process of an exterior part of the wire harness according to the embodiment.

FIG. 6 is a perspective view of a wire harness according to a first modification of the embodiment.

FIG. 7 is a perspective view of a wire harness according to a second modification of the embodiment.

FIG. 8 is a perspective view of a wire harness of a conventional example.

FIG. 9 is a figure illustrating a manufacturing process of the wire harness according to the conventional example.

### DESCRIPTION OF EMBODIMENTS

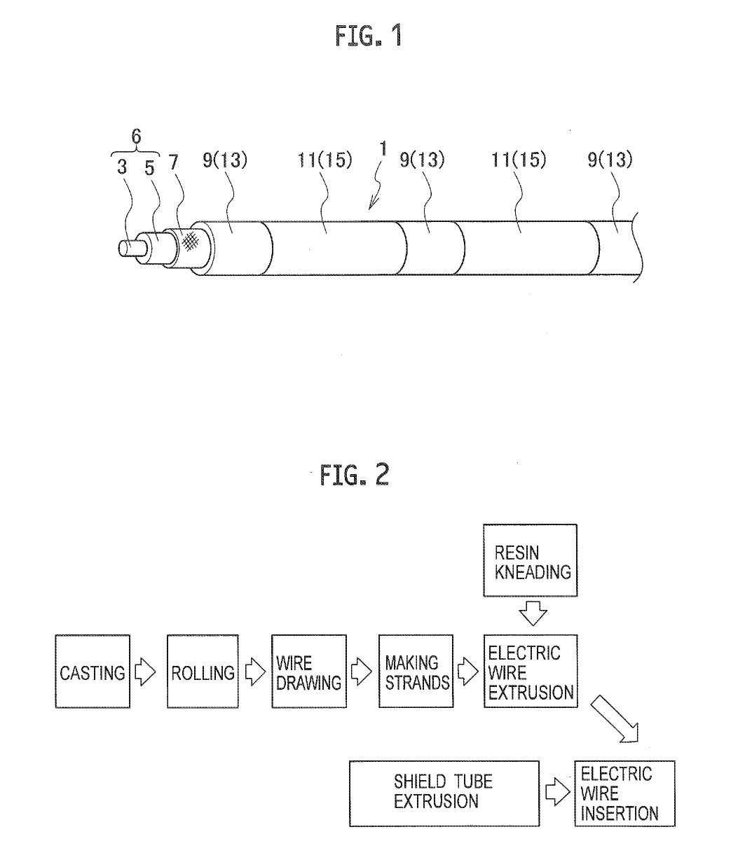

Hereinafter, an embodiment will be explained by referring to the drawings. A wire harness 1 according to the embodiment includes, as illustrated in FIG. 1, an electric wire 6 including a conductor part 3 as a core wire and an insulator part 5 as an internal insulating layer; a shield part 7 composed of a braided wire; a first exterior part 9; and a second exterior part 11.

The conductor part 3 is composed for example of a stranded wire in which a number of long and narrow columnar metal element wires are bundled. The insulator part 5 for example is formed cylindrically of insulating synthetic resin and continuously covers the conductor part 3 in the longitudinal direction. With this, the electric wire 6 is formed. The shield part 7 for example is a braided wire which is formed cylindrically by braiding a number of long and narrow columnar metal element wires, and is formed as a separate body from the electric wire 6, and continuously covers the electric wire 6 (the insulator part 5) in the longitudinal direction.

As the structure of the shield part 7, a tubular braid of aluminum, copper, metal-plated resin fiber or the like, and their woven fabric, non-woven fabric, and in addition, metallic foil of copper or the like, or those coated with resin thereto may be adopted.

The conductor part 3 extends to penetrate into the inside of the insulator part 5. The insulator part 5 covers the conductor part 3 in contact with the conductor part 3. The insulator part 5 extends to penetrate into the inside of the cylindrical shield part 7. The shield part 7 covers the insulator part 5 in contact with the insulator part 5. The central axis of the conductor part 3, the central axis of the insulator part 5, and the central axis of the shield part 7 coincide with each other. The conductor part 3, the insulator part 5, and the shield part 7 have flexibility.

The first exterior part 9 is structured to be rigid, and for example is formed cylindrically of insulating synthetic resin, and covers the shield part 7 intermittently in the longitudinal direction of the conductor part 3, the insulator part 5, and the shield part 7.

The shield part 7 extends to penetrate into the inside of the cylindrical first exterior part 9. The first exterior part 9 is composed of a plurality of cylindrical first exterior part components 13, and each of the first exterior part components 13 is arranged at a given interval in the longitudinal direction of the shield part 7 to cover the shield part 7 in contact with the shield part 7. Moreover, the central axis of the first exterior part 9 and the central axis of the shield part 7 coincide with each other.

The first exterior part 9 (the first exterior part component 13) is hard and has a rigidity to the degree that can be regarded almost as a rigid body, and it is made such that it is hardly deformed with the degree of a force that is applied by a person with bear hands. Further, it may be made such that when an even greater force is applied to the first exterior part 9, the first exterior part 9 is hardly deformed, and for example it may show the characteristics as a brittle material.

The first exterior part 9 (the first exterior part component 13) specifically is composed of a resin such as polypropylene, high density polyethylene, PET (polyethylene terephthalate), PA (polyamide) or the like that exhibits a tensile modules of elasticity of 1000 to 4000 MPa.

Moreover, while the first exterior part 9 extends straight in FIG. 1 or the like, the first exterior part 9 may extend to be bent in a circular arc state or the like.

The second exterior part 11 is configured in a state that is soft and has flexibility, and for example is formed cylindrically of insulating synthetic resin, and is provided between the first exterior part 9, and in cooperation with the first exterior part 9 covers the shield part 7 continuously in the longitudinal direction of the conductor part 3, the insulator part 5, and the shield part 7.

The shield part 7 extends to penetrate into the inside of the cylindrical second exterior part 11. The second exterior part 11 is composed of a plurality of cylindrical second exterior part components 15. Each of the second exterior part components 15 covers the shield part 7 in contact with the shield part 7. The inner and outer diameters of the second exterior part 11 mutually coincide with the inner and outer diameters of the first exterior part 9. The central axis of the second exterior part 11 and the central axis of the shield part 7 coincide with each other. Each first exterior part component 13 and each second exterior part component 15 are alternately aligned in the longitudinal direction of the shield part 7.

The conductor part 3, the insulator part 5, the shield part 7, the first exterior part 9, and the second exterior part 11 are integrated, and for example are made so as not to shift their mutual positions in the longitudinal direction of the wire harness 1.

Moreover, the joint between the first exterior part component 13 and the second exterior part component 15 has sealability.

The second exterior part 11 (the second exterior part component 15) has flexibility and it is made such that it can be deformed (for example elastically deformed) with a degree of the force that is applied by a person with bear hands.

The second exterior part 11 (the second exterior part component 15) specifically is composed of SEBS (hydrogenated styrene-based thermoplastic elastomer) or soft olefin-based resin or the like that exhibits a tensile modules of elasticity of 30 to 990 MPa.

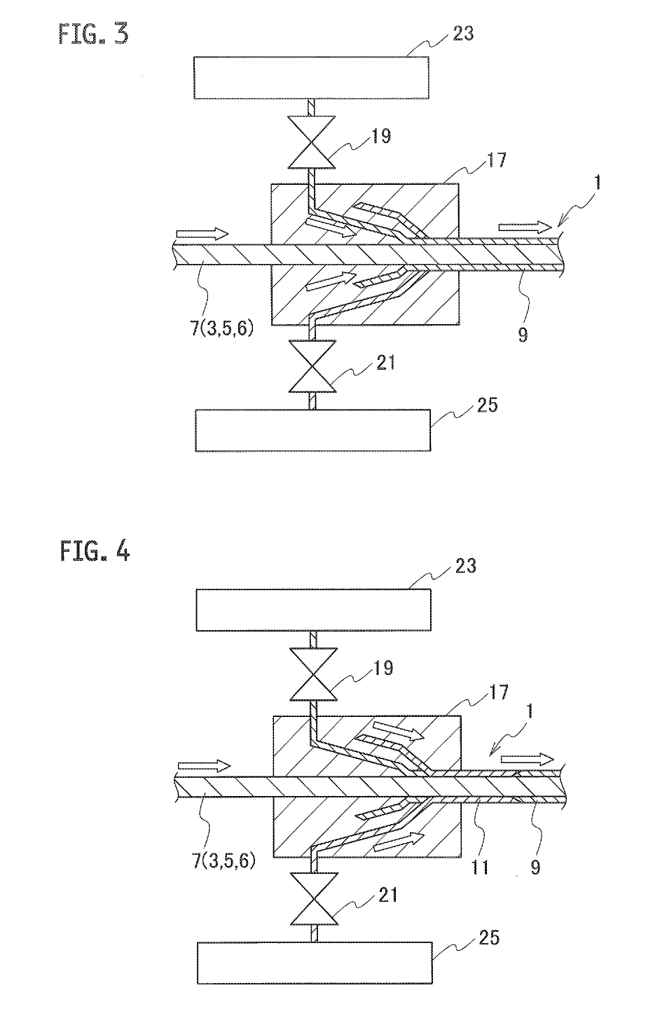

In the wire harness 1, the first exterior part 9 and the second exterior part 11 are batch molded by coextrusion. In other words, as illustrated for example in FIG. 3, the electric wire 6 and the shield part 7 are let to pass through a head (metal mold) 17, and the electric wire 6 and the shield part 7 are moved at a regular speed in the longitudinal direction of the electric wire 6 and the shield part 7. At this time, by switching a first valve 19 and a second valve 21, the kind of resin that coats the shield part 7 at the head 17 is alternately switched thereby forming the first exterior part 9 and the second exterior part 11 alternately and yet continuously. Moreover, what is illustrated by reference number 23 in FIG. 3 or the like is a first extruder that supplies resin that constitutes the first exterior part 9, and what is illustrated by reference number 25 in FIG. 3 or the like is a second extruder that supplies resin that constitutes the second exterior part 11.

Next, a manufacturing process of the wire harness 1 will be explained by referring to FIGS. 2 to 5.

First, as illustrated in FIG. 2, the conductor part 3 is generated by casting, rolling, wire drawing, and making strands of a material of the conductor part 3.

Subsequently, the conductor part 3 is coated with the insulator part 5 by utilizing a metal mold (not illustrated) by supplying kneaded resin from an extruder (not illustrated) while extruding the conductor part 3, thereby forming the electric wire 6.

Subsequently, the shield part 7 is installed on the outer periphery of the electric wire 6 thereby to insert the electric wire 6 into the cylindrical shield part 7, and the first exterior part 9 and the second exterior part 11 are installed on the outer periphery of the shield part 7.

Here, the installation of the first exterior part 9 and the second exterior part 11 will be explained in details.

As illustrated in FIG. 3, the shield part 7 that has been inserted into the electric wire 6 is let to pass through the head 17, and these are moved in the longitudinal direction thereof.

At the time of this movement, the first valve 19 is opened to supply resin from the first extruder 23 to install the first exterior part 9 on the outer periphery of the shield part 7.

Subsequently, while continuing with the above movement, the first valve 19 is closed and at the same time the second valve 21 is opened to supply resin from the second extruder 25, as illustrated in FIG. 4, to install the second exterior part 11 on the outer periphery of the shield part 7.

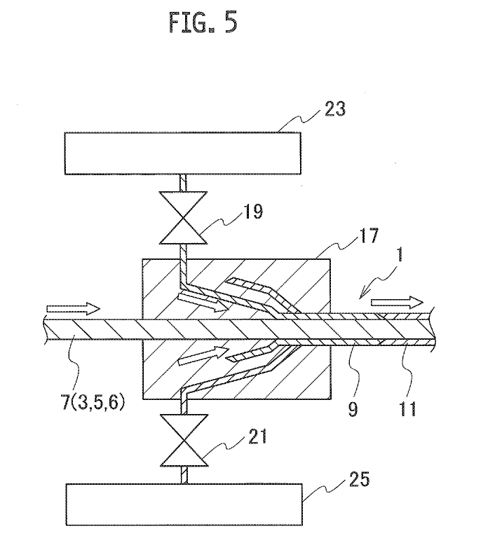

Subsequently, as illustrated in FIG. 5, the second valve 21 is closed and at the same time the first valve 19 is opened to supply resin from the first extruder 23 to install the first exterior part 9 on the outer periphery of the shield part 7. By alternately repeating these operations, the first exterior part 9 and the second exterior part 11 are installed.

According to the wire harness 1, since the corrugate is unnecessary, the manufacturing process becomes simplified and the manufacturing time is shortened, and increase in the cost can be suppressed.

Moreover, according to the wire harness 1, since the rigid first exterior part 9 intermittently covers the shield part 7 in the longitudinal direction, assembly workability to the wire harness installation body of a vehicle or the like becomes good, and its durability against friction, crushing or the like also is heightened.

In other words, when assembling to a wire harness installation body of a vehicle or the like, in the wire harness 1, there is naturally a need to have a part that should not be deformed and a part that requires flexibility since it is necessary to have durability against friction, crushing or the like and also in order to be disposed along a wiring path.

Thus, if the rigid first exterior part 9 is provided conforming with the above needs, it is possible to bend the wire harness 1 at a part where the rigid first exterior part 9 is not provided (the part of the second exterior part 11) to improve assemble workability to the wire harness installation body of a vehicle or the like, and durability against friction, crushing or the like is heightened at a part of the rigid first exterior part 9, thereby protecting the inner part from the external interference with the first exterior part 9.

Moreover, since the shield part 7 is provided, noise generation by the electromagnetic waves from inside of the shield part 7 to the outside is suppressed, and thus, a bad influence to the electronic equipment outside of the wire harness or to the other wire harnesses can be suppressed, and further, it is possible to prevent noise from entering into the shield part 7.

Furthermore, according to the wire harness 1, the shield part 7 can be reliably sealed since the second exterior part 11 is provided between the first exterior part 9, and the second exterior part 11 in cooperation with the first exterior part 9 continuously covers the shield part 7 in the longitudinal direction of the wire harness 1.

Moreover, according to the wire harness 1, since each exterior part 9, 11 are batch molded by coextrusion, the manufacturing process of the wire harness 1 is simplified, and it is possible to reduce the manufacturing cost of the wire harness 1.

In the above explanation, the shield part 7 contacts each exterior part 9, 11, but it may be made such that each exterior part 9, 11 are separated from the shield part 7 to form a cylindrical gap between the shield part 7 and each exterior part 9, 11. In this case, it may be made such that each exterior part 9, 11 are separately formed, and thereafter, the shield part 7 (the conductor part 3, the insulator part 5) is inserted into each cylindrical exterior part 9, 11.

In this manner, even with a structure in which each exterior part 9, 11 are separated from the shield part 7, the inner surface of each circular exterior part 9, 11 does not become uneven unlike the corrugate, and is smooth in a cylindrical side-surface state. Therefore, the shield part 7 does not become damaged due to vibration or the like, and breaking of the shield part 7 or the like can be avoided.

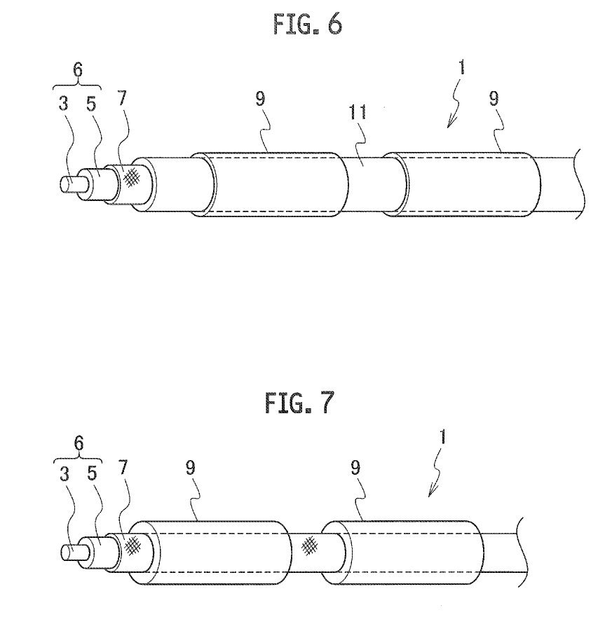

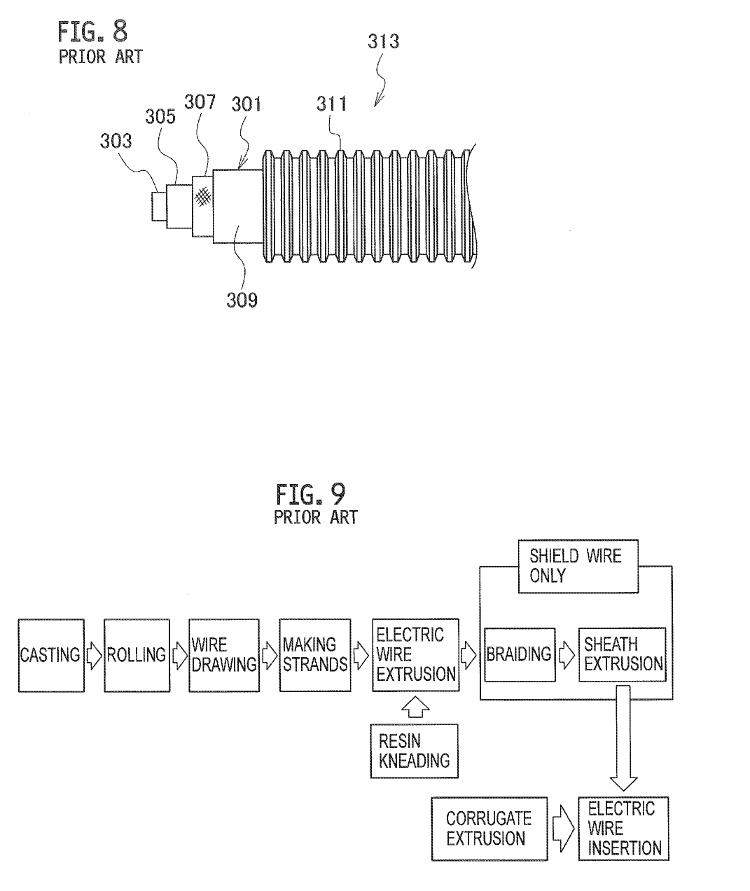

Moreover, as in a first modification as illustrated in FIG. 6, it may be made such that the second exterior part 11 is provided over the full length of the wire harness 1, and the first exterior part 9 is provided intermittently on the outer periphery of the second exterior part 11.

That is, it may be made such that the second exterior part 11 is provided so as to continuously cover the shield part 7 in contact with the shield part 7 in the longitudinal direction of the shield part 7, and the first exterior part 9 is provided to intermittently cover the second exterior part 11 in contact with the second exterior part 11 in the longitudinal direction of the second exterior part 11.

By constructing it this way, the flexible second exterior part 11 continuously covers the shield part 7 in the longitudinal direction of the shield part 7, and thus it is possible to seal the shield part 7 more certainly.

Furthermore, in the above explanation, while it was explained using the wire harness 1 in which one electric wire 6 is covered with one shield part 7 or the like, it may have a structure in which two or more multiple electric wires 6 are covered with one shield part 7 and the first exterior part 9 and the second exterior part 11 cover the shield part 7.

Furthermore, it may have a structure in which two or more multiple electric wires 6 are covered with multiple shield parts 7 respectively, and these shield parts 7 are covered with the first exterior part 9 and the second exterior part 11.

Further, in the wire harness 1, as in a second modification as illustrated in FIG. 7, the second exterior part 11 may be removed.

Further, in the wire harness 1, the shield part 7 may be removed. That is, the wire harness 1 may be structured with one or more electric wire 6 composed of the conductor part 3 and the insulator part 5 that covers this conductor part 3, and the rigid first exterior part 9 which is composed of a separate body from the electric wire 6 and which intermittently covers the insulator part 5 in the longitudinal direction of the electric wire 6.

What is claimed is:

1. A wire harness, comprising:
one or more electric wires each including a conductor part and an insulator part that covers the conductor part;
a shield part that is composed of a separate body from the electric wires and covers the electric wires; and
a first exterior part that is composed of a rigid resin formed by an extrusion molding and intermittently covers the shield part in the longitudinal direction of the shield part.

2. The wire harness according to claim 1, further comprising
a second exterior part that is composed of a flexible resin formed by a coextrusion molding with the first exterior part, that is provided between the first exterior part, and that continuously covers the shield part in the longitudinal direction of the shield part in cooperation with the first exterior part.

3. The wire harness according to claim 1, further comprising
a second exterior part that is composed of a flexible resin formed by an extrusion molding and continuously covers the shield part in the longitudinal direction of the shield part, wherein
the first exterior part is formed by the extrusion molding on the second exterior part and intermittently covers the second exterior part in the longitudinal direction of the second exterior part.

4. A wire harness, comprising:
one or more electric wires each including a conductor part and an insulator part that covers the conductor part; and
an exterior part that is composed of a rigid resin formed by an extrusion molding on the electric wires and intermittently covers the insulator parts in the longitudinal direction of the electric wires.
